(19) United States
(12) Patent Application Publication
(10) Pub. No.: US 2015/0332327 A1
(43) Pub. Date: Nov. 19, 2015

(54) RETAIL STORE AUDIO VIDEO FEATURE DEMONSTRATION SYSTEM

(71) Applicant: Sony Corporation, Tokyo (JP)

(72) Inventors: Steven Friedlander, San Diego, CA (US); Liviu Burciu, San Diego, CA (US); David George Thiele, San Diego, CA (US)

(73) Assignee: Sony Corporation, Tokyo (JP)

(21) Appl. No.: 14/276,873

(22) Filed: May 13, 2014

(51) Int. Cl. G06Q 30/02; H04N 5/44; H04N 5/66

(52) U.S. Cl. CPC G06Q 30/0261; H04N 5/66; H04N 5/4403; H04N 2005/4408; H04N 2005/4425

(57) ABSTRACT

A retail display arrangement includes multiple video displays disposed on a wall in an arrangement. A content server causes a shopper terminal to present a user interface (UI) with video feature selectors. A shopper can select a feature and in response the content server sends content enhanced with the feature to some but not all of the displays, with the same content, not enhanced with the feature, being shown on a remaining display to better illustrate the feature to the shopper. The UI presents windows mimicking the display arrangement, and each window indicates whether the corresponding display on the wall presents content enhanced with the feature.

### FIELD OF THE INVENTION

The application relates generally to retail store audio video feature demonstration systems.

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

### SUMMARY OF THE INVENTION

An example ecosystem that is pertinent here is an entertainment ecosystem in a retail store in which shoppers view multiple video displays and in which the vendor seeks to demonstrate one or more enhanced features of a display in a clear and convenient way.

Accordingly, a device includes at least one processor and at least one computer memory associated with the processor and bearing instructions which when executed by the processor configure the processor to send, to a shopper terminal remote from the device, data to cause the shopper terminal to render on a controller display of the shopper terminal a first user interface (UI) having plural selectors. Each selector is associated with a respective audio or video feature on a video display. The instructions when executed by the processor configure the processor to receive input from the shopper terminal indicating selection of a first selector of the plural selectors. The first selector is associated with a first video feature. Also, the instructions when executed by the processor configure the processor to, responsive to the input indicating selection of the first selector, cause a first display among plural displays to present content having the first video feature and cause a second display among the plural displays to present the same content as the first display but not having the first video feature. The instructions when executed by the processor configure the processor to, responsive to the input indicating selection of the first selector, cause the shopper terminal to modify the first UI to a second UI showing the plural selectors and also presenting at least first and second windows respectively representing the first and second displays. The first window indicates that the first display plays content with the first video feature and the second window indicates that the second display plays content without the first video feature.

In some examples, the displays are disposed in a display arrangement, and the windows of the second UI can mimic the display arrangement.

In example embodiments, the device is configured to communicate with the shopper terminal via Ethernet and the data to cause the rendering of the first UI is associated with hypertext transfer protocol language (html)-5. The first UI may present only the plural selectors and no other selectors. The first and second displays can be remote from the device within the retail store. The first and second displays may not be the controller display of the shopper terminal.

The plural displays can include only the first and second displays. Or, the plural displays can include the first and second displays and at least a third display. In this case, the instructions when executed by the processor may cause the processor to, responsive to the input indicating selection of the first selector, cause the shopper terminal to present the second UI also presenting at least a third window representing the third display. The third window indicates the third display plays content with the first video feature.

In an example, the plural displays include five and only five displays arranged in left and right columns of two displays straddling a single central center display.

In some examples the instructions when executed by the processor cause the processor to present a watch more selector on the second UI selectable to cause plural content selectors representing respective content sources to be presented, responsive to selection of which content is presented on at least some of the displays. In implementations the instructions when executed by the processor cause the processor to present plural video format selectors responsive to selection of one of which video with a respective video format is presented on at least one of the display.

In another aspect, a retail display exhibit includes plural video displays disposed on a wall in an arrangement. A content server is configured to cause a shopper terminal to present a user interface (UI) with video feature selectors. The content server is configured to, responsive to selection of a feature selector, send content enhanced with a video feature associated with the feature selector selected by a shopper to some but not all of the displays, with the server being configured to send the same content, not enhanced with the feature, to at least one remaining display to better illustrate the feature to the shopper.

In another aspect, a device has at least one display configured to present a first user interface (UI). The first UI includes plural selectors, with each selector being associated with a respective video feature on a video display. A selector is selectable by a person to input a command to present content on a first display having the respective video feature and to present the same content on a second display but without the video feature. Also, a selector is selectable to cause a second UI to be presented on the display. The second UI presents plural windows respectively representing video displays including the first and second displays, with a first window indicating the first display presents content with the first video feature and a second window indicating the second display plays content without the video feature.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a schematic diagram of an example system including an example in accordance with present principles;

FIGS. 2-4 are screen shots of example UIs served by the server to the shopper terminal;

FIG. 5 is a flow chart of example logic according to present principles; and

FIGS. 6-10 are illustrations of an example exhibit layout in a retail outlet to provide functionality in best presenting product information to shoppers while conserving floor space.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony PlayStation (trademarked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to hypertext transfer protocol language (html)-5, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

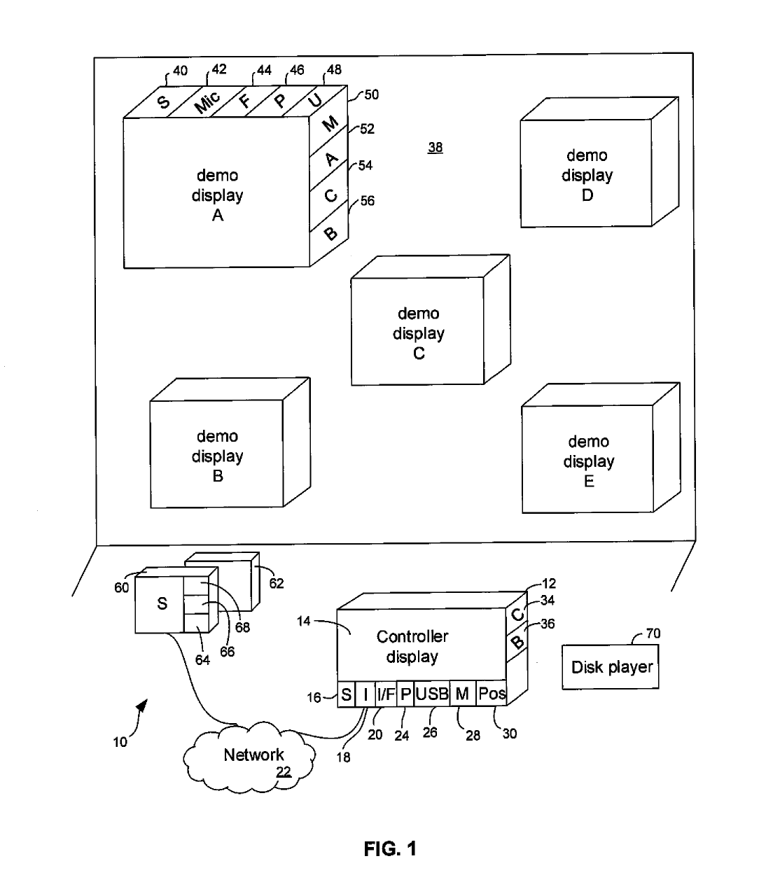

Now specifically referring to FIG. 1, an example ecosystem 10 is shown, which may include one or more of the example devices mentioned above and described further below in accordance with present principles. The first of the example devices included in the system 10 is an example shopper terminal (ST) 12. In a non-limiting example the ST 12 may be implemented as a network-enabled portable computer such as but not limited to a Sony VAIO® computer. Alternatively the ST 12 may be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, etc. Regardless, it is to be understood that the ST 12 is configured to undertake present principles (e.g. communicate with other CE devices to undertake present principles, execute the logic described herein, and perform any other functions and/or operations described herein). Note that because in an example embodiment the below-described server executes the bulk of the logic, serving UIs to the ST 12 and responding to UI selections to control content presentation on various displays, the ST 12 may be a thin client. Regardless, the disclosure below is presented for completeness with the understanding that not all the components discussed below need be incorporated into the ST 12.

Accordingly, to undertake such principles the ST 12 can be established by some or all of the components shown in FIG. 1. For example, the ST 12 can include one or more controller displays 14 that may be touch-enabled for receiving user input signals via touches on the display. The ST 12 may include one or more speakers 16 for outputting audio in accordance with present principles, and at least one additional input device 18 such as e.g. an audio receiver/microphone for e.g. entering audible commands to the ST 12 to control the ST 12. The example ST 12 may also include one or more network interfaces 20 for communication over at least one network 22 such as the Internet, an WAN, a LAN such as a wired or wireless Ethernet LAN, etc. under control of one or more processors 24. Thus, the interface 20 may be, without limitation, a Wi-Fi transceiver, which is an example of a wireless computer network interface, or it may be a wired modem connectable to a wired Ethernet LAN. It is to be understood that the processor 24 controls the ST 12 to undertake present principles, including the other elements of the ST 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the ST 12 may also include one or more input ports 26 such as, e.g., a USB port to physically connect (e.g. using a wired connection) to another CE device and/or a headphone port to connect headphones to the ST 12 for presentation of audio from the ST 12 to a user through the headphones. The ST 12 may further include one or more tangible computer readable storage medium 28 such as disk-based or solid state storage. Also in some embodiments, the ST 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the ST 12 is disposed in conjunction with the processor 24. However, it is to be understood that that another suitable position receiver other than a cellphone receiver, GPS receiver and/or altimeter may be used in accordance with present principles to e.g. determine the location of the ST 12 in e.g. all three dimensions.

Continuing the description of the ST 12, in some embodiments the ST 12 may include one or more cameras 32 that may be, e.g., a thermal imaging camera, a digital camera such as a webcam, and/or a camera integrated into the ST 12 and controllable by the processor 24 to gather pictures/images and/or video in accordance with present principles. Also included on the ST 12 may be a Bluetooth transceiver 34 or other Near Field Communication (NFC) element such as a radio frequency identification (RFID) element.

Infrared (IR) transceiving components may also be provided in examples. A battery (not shown) may be provided for powering the ST 12.

In general, the components of this device communicate with one or more data buses within the device to provide input to and receive out from the processor of the device.

Still referring to FIG. 1, in addition to the ST 12, the system 10 may include one or more other CE device types. In the example shown, the system 10 includes plural demonstration video displays A-E on a wall 38 of a building such as a retail establishment. In the specific example shown, five demonstration displays A-E are disposed on the wall in an arrangement in which left and right display columns are established by the displays A, B and D, E, respectively, and a fifth display C is disposed between the columns, below the top two displays A, D and above the lower two displays B, E as shown, similar to the dot arrangement of the “5” face of gaming dice. Each demonstration display may be implemented by a high definition “2K” and/or ultra-high definition “4K” flat screen. In one non-limiting example the demonstration displays A, B, and C are 4K video displays and the demonstration displays D and E are 2K video displays. In the example shown, the most advanced display is the middle display C, the next two “best” displays are the left displays A and B, and the acceptable albeit least advanced displays are the two right displays D and E.

Taking the upper left demonstration display A as an example, it being understood that the remaining displays have similar components. The display A may include one or more speakers 40 for outputting audio in accordance with present principles, and at least one additional input device 42 such as e.g. an audio receiver/microphone for e.g. entering audible commands to the display A. The example display A may also include one or more network interfaces 44 for communication over the network 22 under control of one or more display processors 46. Thus, the interface 44 may be, without limitation, a Wi-Fi transceiver, which is an example of a wireless computer network interface, a wired Ethernet interface, etc. It is to be understood that the processor 46 presents demanded images on the display A. Furthermore, note the network interface 44 may be, e.g., a wired or wireless modem or router, or other appropriate interface such as, e.g., a wireless telephony transceiver, or Wi-Fi transceiver as mentioned above, etc.

In addition to the foregoing, the display A may also include one or more input ports 48 such as, e.g., a USB port to physically connect (e.g. using a wired connection) to another CE device and/or a headphone port to connect headphones to the display A for presentation of audio from the display A to a user through the headphones. The display A may further include one or more tangible computer readable storage medium 50 such as disk-based or solid state storage. Also in some embodiments, the display A can include a position or location receiver such as but not limited to a cellphone and/or GPS receiver and/or altimeter 52 that is configured to e.g. receive geographic position information from at least one satellite and/or cell tower, using triangulation, and provide the information to the display processor 46 and/or determine an altitude at which the display A is disposed in conjunction with the processor 46. However, it is to be understood that that another suitable position receiver other than a cellphone and/or GPS receiver and/or altimeter may be used in accordance with present principles to e.g. determine the location of the display A in e.g. all three dimensions.

In some embodiments the display A may include one or more cameras 54 that may be, e.g., a thermal imaging camera, a digital camera such as a webcam, and/or a camera integrated into the display A and controllable by the display A to gather pictures/images and/or video in accordance with present principles. Also included on the display A may be a Bluetooth transceiver 56 and/or other Near Field Communication (NFC) element such as a radio frequency identification (RFID) element.

In addition to the foregoing, it is noted that in some embodiments the display A may also include an infrared (IR) transmitter and/or IR receiver and/or IR transceiver such as an IR data association (IRDA) device. A battery (not shown) may be provided for powering the display A. In general, the components of this device communicate with one or more data buses within the device to provide input to and receive out from the processor of the device.

The other demonstration displays B-E may include some or all of the components shown for the display A.

The system 10 may also include one or more content servers. In the non-limiting example shown, the system 10 includes a 4K video server 60 and a 2K video server 62 that is controlled by the 4K video server 60. Each server typically includes at least one server processor 64, at least one tangible computer readable storage medium 66 such as disk-based or solid state storage, and at least one network interface 68 that, under control of the server processor 64, allows for communication with the other devices of FIG. 1 over the network 22, and indeed may facilitate communication between servers and client devices in accordance with present principles. Note that the network interface 68 may be, e.g., a wired or wireless modem or router, Wi-Fi transceiver, or other appropriate interface such as, e.g., a wireless telephony transceiver.

Accordingly, in some embodiments the server 60 may be an Internet server, and may include and perform “cloud” functions such that the devices of the system 10 may access a “cloud” environment via the server 80 in example embodiments. Or, the server 60 may be implemented by a game console or other computer in the same room as the other devices shown in FIG. 1 or nearby.

Sources of video content may be included such as a disk player 70 (e.g., a Blu-Ray® player) and televised or Internet video sources (e.g., satellite receivers, cable boxes, terrestrial TV antennas, etc.)

In the example discussed below, the 4K video server 60 provides, via the network 22, user interfaces (UI) to the shopper terminal 12 for presentation of the UIs on the controller display 14. The UIs are presented according to html-5, and input received from the UIs is sent over the network 22 to the server 60, which in response executes actions including presenting additional UIs on the shopper terminal 12 and providing video content to one or more of the demonstration displays A-E, controlling the example 2K video server 62 to provide video content to some of the other demonstration video displays.

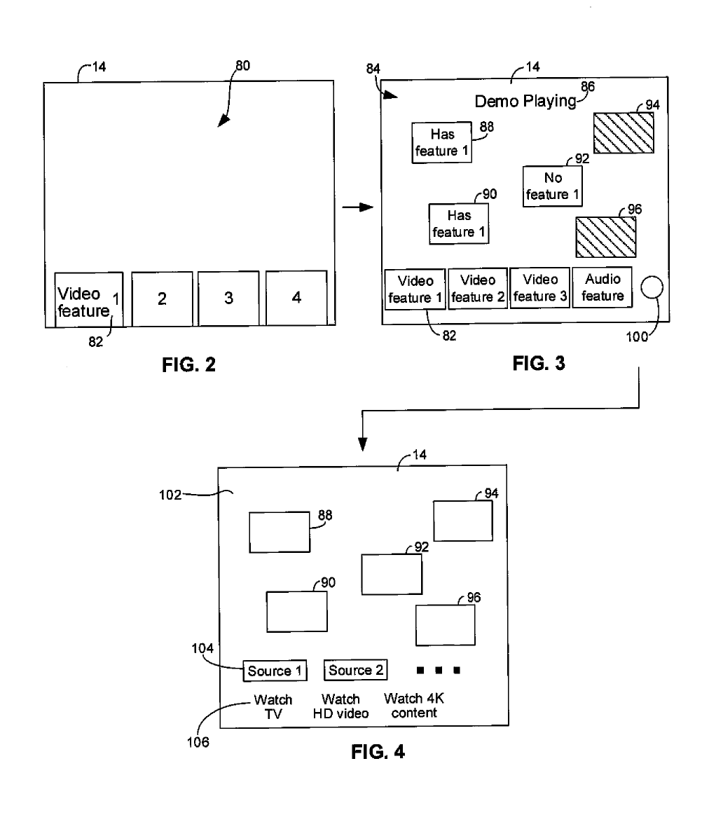

Accordingly and now turning to FIGS. 2-4, a home UI 80 is served by the server to the ST 12 for display thereof on the controller display 14. As shown, the home UI is simple, consisting of a few feature selectors 82, in the example shown, four selectors 82, each labeled with a respective feature. In one example the left three selectors 82 are associated with respective video features and the right-most selector 82 is associated with an audio feature, e.g., “soundbar”. The video features may be any appropriate video enhancement that the manufacturer wishes to draw attention to, such as an enhanced brightness feature, or other advanced video feature. Such features typically are embodied as algorithms which a content server applies to content to alter the content in some way.

The selectors 82 may have identical sizes and shapes as each other. No other selectors are presented on the example home UI of FIG. 2.

A shopper can select, as by touching the display 14, one of the selectors 82. The ST 12 sends a signal indicating this selection to the server 60, which in response serves the UI 84 of FIG. 3 for presentation on the display 14 of the ST 12. In the UI 84, the feature selectors 82 remain, and a message 86 indicating that demonstration video is being presented on plural of the displays A-E shown in FIG. 1 is presented.

Furthermore, the server 60 responsive to the input from the ST 12 indicating selection of the feature selector causes the UI 84 served to the ST 12 to present plural windows 88, 90, 92, 94, 96 respectively representing the displays A-E shown in FIG. 1. As shown, in an example embodiment, the displays A-E are disposed in a display arrangement, and the windows 88-96 of the UI 84 are presented in an arrangement on the display 14 that mimics the display arrangement on the wall 38.

Along with serving the UI 84 to the St 12 responsive to user selection of a video feature selector 82, the server serves content to multiple displays A-E in consonance with the shopper selection. With more specificity, the server serves content to one or more of the displays in which the video feature (or enhancement) is embodied, while simultaneously serving the same content but without the video feature or enhancement to at least one other display. As may now be appreciated, this facilitates visual comparison of content by the shopper by conveniently showing the identical content side by side, with and without the selected video feature. For example, content may be presented with the selected video feature on the left and right displays A and B in FIG. 1 while the same content may be presented on the center display C in FIG. 1, without the video feature. The right most displays D and E may present other unrelated content, or may also present the same content with or without the selected video feature.

The skilled artisan may now recognize that the server processor 64 operates on the digital file of the content to according to the selected video feature, e.g., enhanced brightness, and presents that enhanced content on one or more of the displays A-E, while presenting the identical content but without having been processed according to the selected video feature on at least one other display.

To inform the shopper of what is happening, respective messages 98 cam ne presented in or near the windows 88-96 as appropriate indicating whether the corresponding display A-E does or does not present content with the selected video feature. Thus, for example, the windows 88 and 90 indicate that their respective displays A and B are showing content with the selected video feature, while the window 92 indicates that its respective display C is displaying content without the selected video feature.

Note that if a selector 82 is selected that represents an underlying audio feature, audio may be immediately and automatically played on only a single one of the display A-E, e.g., the center display C, having the selected audio feature, e.g., enhanced bass. The window 92 in this case can bear a message or other indication that the center display C is playing audio with the selected audio feature.

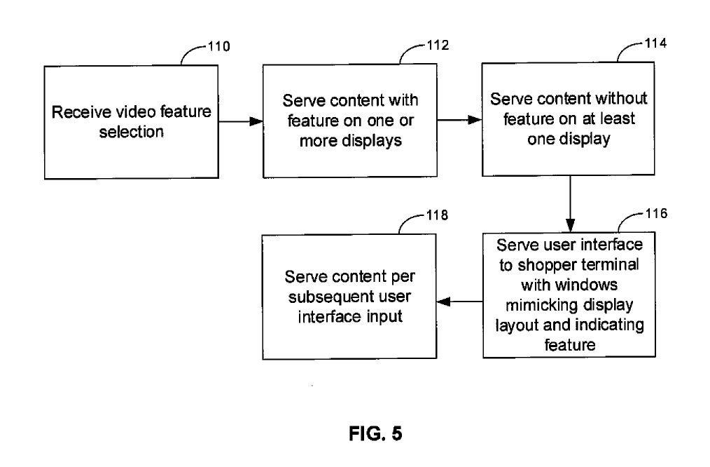

A “more” selector 100 may also be presented on the UI 84 which if selected invokes the UI 102 of FIG. 4, like the other UIs served to the ST 12 by the server 60. As shown, the windows 88-96 remain in the UI 102 but the feature selectors 82 are replaced with a row of content source selectors 104. Each content source selector 104 when invoked causes content from a respective source, such as a TV channel, Internet channel, disk player, etc. to be presented on the displays A-E. That is, the ST 12 sends a signal to the server 60 indicating that a particular content source has been selected, and the server 69 then causes the content served to the displays A-E to be content from the selected source. To invoke a source selector 104 the shopper can drag and drop it onto a window 88-96.

Additionally, below the source selectors 104 a row of content type selectors 106 may be presented. In one example, the content type selectors include “TV”, “HD video” (which if selected causes the server to present HD video on one or more displays), “4K content” (which if selected causes the server to present 4K video on one or more displays), and “upscale 2K->4K”. If this latter content type selector 106 is selected, the server retrieves a 2K content stream, upscales it to 4K, and presents the upscaled vide on one or more of the displays A-E, with the windows 88-96 bearing indications as to which display(s) are showing upscaled 2K content. Again, selection may be by drag and drop onto a desired one of the windows so that the shopper can command which display presents the shopper selection.

FIG. 5 illustrate aspects of logic mentioned above. At block 110 a video feature selection is received from the ST 12. This causes the server 60 to alter demonstration content to have the selected feature and serve that content onto one or more displays A-E at block 112. As stated previously, for comparison purposes the server 60 also serves the exact same content but without the video feature to another display at block 114. Content may be initially downloaded to the content server 60. The content provided is selected to highlight the currently available features that are selectable by the consumer. In some embodiments, 2K content is parsed only to 2K displays and 4K content is parsed only to 4K displays, although as discussed elsewhere herein 2K content can be upscaled to 4K content for presentation on an appropriate display.

Also, as indicated at block 116, in response to shopper selection of a video feature the server 60 also serves the UI 84 of FIG. 3 to the ST 12, showing the windows 88-96 in the same layout as the display arrangement on the wall 38. Block 118 simply indicates that content subsequently is served to the displays A-E according to shopper input to the UIs of FIGS. 3 and 4.

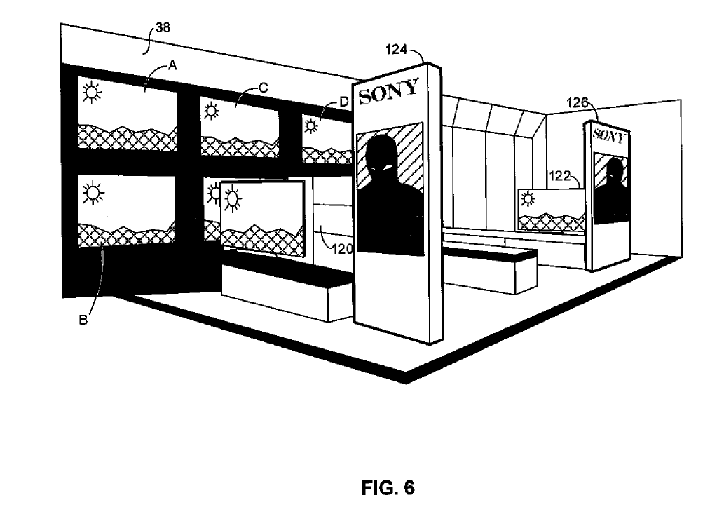

FIGS. 6-10 are illustrations of an example in-store exhibit. As shown in FIG. 6, the wall 38 bears the displays A-E (display E in FIG. 1 is not shown in FIG. 6) as described previously. Extending perpendicularly away from the wall 38 and spaced therefrom to permit shopper movement therebetween are left and right “gondolas” 120, 122 each having a respective inner and outer display surface. Capping the ends of the gondolas 120, 122 on the side opposite the wall 38 are respective left and right graphics totems 124, 126 which as shown may be higher than the gondolas and may be oriented perpendicularly to the wall 38 or obliquely angled (as shown for the right totem 126) with respect to the wall 38. Preferably, lamps are arranged inside the totems 124, 126 to provide backlighting for graphics presented on the totems 124, 126.

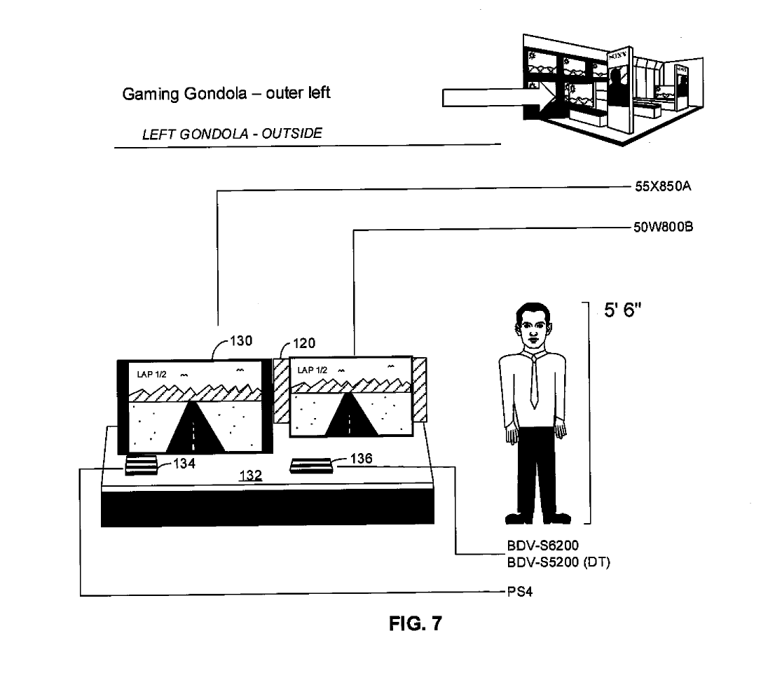

FIG. 7 illustrates an example outer display surface for the left gondola 120 shown in FIG. 6. The outer wall can bear side-by-side displays 130 and on shelf 132 under the displays 130, a game console 134 and a disk player 136. Content for the displays 130 may be sourced from wither one of the components 134, 136 on the shelf and one component may provide input to one display while the other component may provide input to the other display.

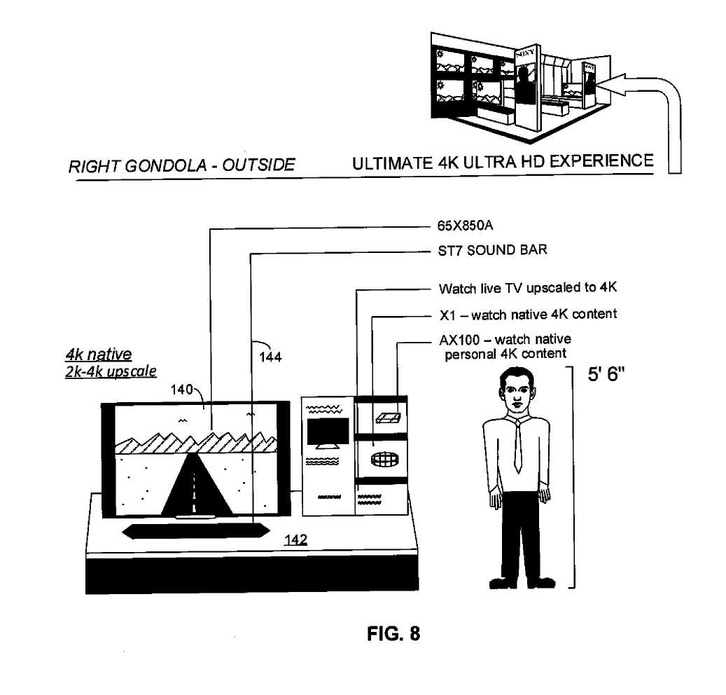

FIG. 8 illustrates an example outer display surface for the right gondola 122 shown in FIG. 6. A display 140 may be presented and on a shelf 142 under the display, an audio sound bar 144 may be disposed. Next to the display 140, a selector station 146 may be disposed with a column of manual selector elements to cause the display 140 to present, respectively, TV content upscaled to 4K, content in native 4K format, and native personal 4K content.

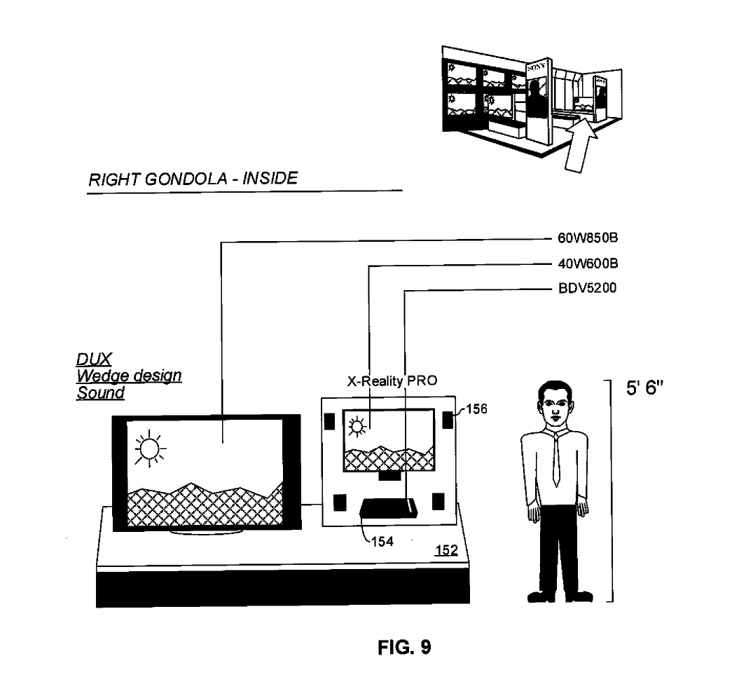

FIG. 9 illustrates an example inner display surface for the right gondola 122 shown in FIG. 6. The inner surface may bear two displays 150 side by side of the same or different model and on a shelf 152 below the displays, a disk player 154. Audio speakers 156 may be mounted on the inner surface to surround one or both displays to play audio associated with content being presented on the displays.

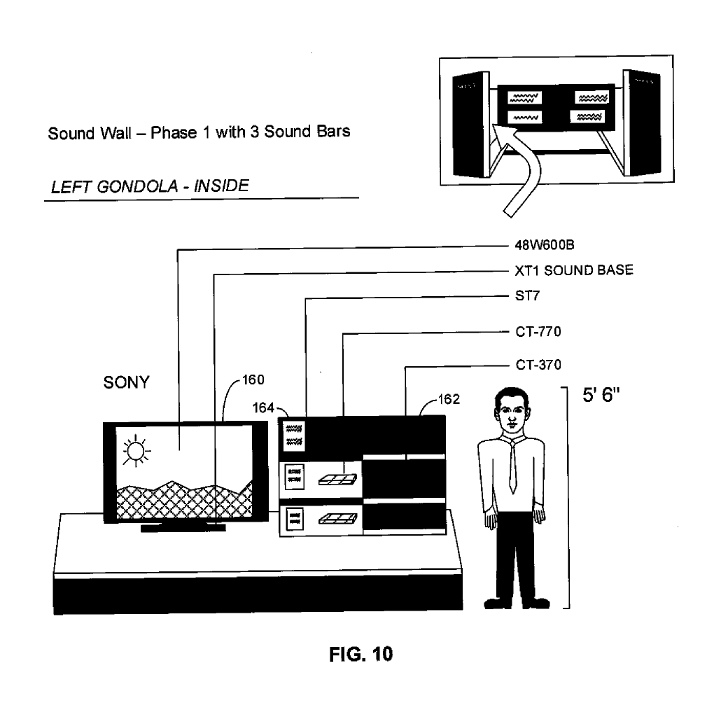

FIG. 10 illustrates an example inner display surface for the left gondola 120 shown in FIG. 6. A display 160 may be mounted on the inner surface and next to the display a column of audio sound bars 162 can be mounted on the wall. A shopper can select a sound bar by means of a respective selector button or other element 164 to cause the selected soundbar to play audio associated with video being presented on the display 160. In this way, shoppers can compare soundbars.

While the particular RETAIL STORE AUDIO VIDEO FEATURE DEMONSTRATION SYSTEM is herein shown and described in detail, it is to be understood that the subject matter which is encompassed by the present invention is limited only by the claims.

What is claimed is:

1. Device comprising:
at least one processor;
at least one computer memory associated with the processor and bearing instructions which when executed by the processor configure the processor to:
send, to a shopper terminal remote from the device, data to cause the shopper terminal to render on a controller display of the shopper terminal a first user interface (UI) having plural selectors, each selector being associated with a respective audio or video feature on a video display;
receive input from the shopper terminal indicating selection of a first selector of the plural selectors, the first selector being associated with a first video feature;
responsive to the input indicating selection of the first selector, cause a first display among plural displays to present content having the first video feature and cause a second display among the plural displays to present the same content as the first display but not having the first video feature;
responsive to the input indicating selection of the first selector, cause the shopper terminal to modify the first UI to a second UI showing the plural selectors and also presenting at least first and second windows respectively representing the first and second displays, the first window indicating the first display plays content with the first video feature and the second window indicating the second display plays content without the first video feature.

2. The device of claim 1, wherein the device is configured to communicate with the shopper terminal via Ethernet and the data to cause the rendering of the first UI is associated with hypertext transfer protocol language (html)-5.

3. The device of claim 1, wherein the first UI presents only the plural selectors and no other selectors.

4. The device of claim 1, wherein the first and second displays are remote from the device.

5. The device of claim 1, wherein the first and second displays are not the controller display.

6. The device of claim 1, wherein the plural displays include only the first and second displays.

7. The device of claim 1, wherein the plural displays include the first and second displays and at least a third display.

8. The device of claim 7, wherein the plural displays include five and only five displays arranged in left and right columns of two displays straddling a single central center display.

9. The device of claim 1, wherein the displays are disposed in a display arrangement, and the windows of the second UI mimic the display arrangement.

10. The device of claim 7, wherein the instructions when executed by the processor cause the processor to:
responsive to the input indicating selection of the first selector, cause the shopper terminal to present the second UI also presenting at least a third window representing the third display, the third window indicating the third display plays content with the first video feature.

11. The device of claim 1, wherein the instructions when executed by the processor cause the processor to present a watch more selector on the second UI selectable to cause plural content selectors representing respective content sources to be presented, responsive to selection of which content is presented on at least some of the displays.

12. The device of claim 1, wherein the instructions when executed by the processor cause the processor to present plural video format selectors responsive to selection of one of which video with a respective video format is presented on at least one of the display.

13. A retail display exhibit comprising:
plural video displays disposed on a wall in an arrangement;
a content server configured to cause a shopper terminal to present a user interface (UI) with video feature selectors;
the content server being configured to, responsive to selection of a feature selector, send content enhanced with a video feature associated with the feature selector selected by a shopper to some but not all of the displays, with the server being configured to send the same content, not enhanced with the feature, to at least one remaining display to better illustrate the feature to the shopper.

14. The exhibit of claim 13, wherein the UI presents windows in a layout mimicking the arrangement of the displays, and each window indicates whether a corresponding display on the wall presents content enhanced with the feature.

15. Device comprising;
at least one display configured to present a first user interface (UI), the first UI comprising:
plural selectors, each selector being associated with a respective video feature on a video display;
a selector being selectable by a person to input a command to present content on a first display having the respective video feature and to present the same content on a second display but without the video feature;
a selector being selectable to cause a second UI to be presented on the display, the second UI presenting plural windows respectively representing video displays including the first and second displays, a first window indicating the first display presents content with the first video feature and a second window indicating the second display plays content without the video feature.

16. The device of claim 15, wherein the device is configured to communicate with a content server via Ethernet to receive data therefrom to cause the rendering of the first UI, the data being associated with hypertext transfer protocol language (html)-5.

17. The device of claim 15, wherein the first UI presents only the plural selectors and no other selectors.

18. The device of claim 15, wherein the video displays represented by the windows are disposed in a display arrangement, and the windows of the second UI mimic the display arrangement.

19. The device of claim 15, wherein the second UI presents a watch more selector selectable to cause plural content selectors representing respective content sources to be presented, responsive to selection of which content is presented on at least some of the displays.

20. The device of claim 15, wherein the display is configured to present plural video format selectors responsive to selection of one of which video with a respective video format is presented on at least one of the display.
